(19) United States
(12) Patent Application Publication
(10) Pub. No.: US 2005/0013244 A1
(43) Pub. Date: Jan. 20, 2005

(54) System for actively controlling distributed applications

(76) Inventor: Alexander G Parlos, College Station, TX (US)

Correspondence Address: LALLY & LALLY LLP, PO BOX 684749, AUSTIN, TX, 78768-4749, US

(21) Appl. No.: 10/498,842

(22) PCT Filed: Dec. 13, 2002
(86) PCT No.: PCT/US02/39828

Related U.S. Application Data
(60) Provisional application No. 60/341,605, filed on Dec. 14, 2001.

(51) Int. Cl. H04L 12/26

(52) U.S. Cl. 370/229

(57) ABSTRACT

A method and system for actively controlling transport and delivery of content across best-effort networks (FIG. 3A) includes computing expected content bit rate values (315) associated with a distributed application, and expected quality of service (QoS) metrics (325) for the application. Along with the actual measurements that are indicative of the content bit rate and metrics, the expected bit rates (315) and metrics (325) are used to control the bit rate being generated by the application. The expected bit rates (315) and metrics (325) may be based on measured values of previous bit rates, and metrics, or their various transformations, as well as previously forecasted bit rates and metrics (360), or their various transformations. The forecasting of bit rates and metrics may be facilitated by the use of an appropriate predictive algorithm. In this manner, active control of content being distributed over best-effort networks is achieved without substantially modifying the core network infrastructure.

### CROSS-REFERENCE TO RELATED APPLICATION

This application is related to U.S. provisional patent application Ser. No. 60/341,605, filed Dec. 14, 2001 and entitled “ACTIVE CONTENT CONTROL”. The Applicant hereby claims the benefit of this provisional patent application under 35 U.S.C. §119(e). The entire content of this provisional application is incorporated herein by this reference.

### BACKGROUND OF THE INVENTION

1. Field of the Invention

The present invention relates to computer and communication networks, and more particularly relates to real-time computer-controlled systems for controlling transport and delivery of distributed media or other application content across a standard best-effort network or packet-switched networks, in general.

2. Related Art

Exponential growth in demand for electronic transactions based on Internet and/or intranet technologies are driving the need for a communication infrastructure that can rapidly enable, transport, and guarantee performance for new communications services.

Best-effort networks, such as Internet Protocol (“IP”) networks, enable connectivity between a provider (or source) of information and a consumer (or end-user) of that information. Best-effort networks are typically unable to provide network services beyond connectivity, such as guaranteed performance, common to other types of networks such as an asynchronous transfer mode (“ATM”) networks, since best-effort networks do not allocate network resources to deliver the required services and performance. For example, all packets flowing through an IP network are treated equally on a first-come-first-serve basis. As a result, best-effort networks exhibit substantial variations in their performance such as the delay experienced by packets flowing through the network and the resulting throughput measured in terms of bits transported per unit of time. Distributed application performance requirements are typically defined and included in a Service Level Agreement (“SLA”) between the provider and the consumer, in terms of the application ‘Quality of Service’ (“QoS”).

Presently best-effort networks are typically used for non-real-time applications such as File Transfer Protocol (“FTP”) and e-mail. In such applications, substantial delays or other performance variations do not have an adverse impact on the process being performed by the application. Best-effort networks are also used for certain interactive applications such as web browsing or delivery of non-real-time content, e.g., images or text.

More recently, best-effort networks have been used to transport and deliver multi-media content in non-real-time, e.g., streamed audio and video. Various delay and other performance management techniques, typically referred to as ‘edge-services’, such as content redirecting, buffering, caching, and pre-fetching are used to create a perception of real-time delivery of the media content. For example, Content Delivery Networks (“CDN”) are media delivery systems, or overlay networks, that use edge-services to deliver cacheable media or data content in perceived real-time.

Real-time applications, including multi-media or other distributed software applications operating over uncertain environments such as best-effort networks, typically generate non-cacheable content that is required to be transported to a destination in real-time or near real-time. As referred to herein, ‘real-time’ refers to a class of applications that receive an input and provide a response to the input in a time interval that is sufficiently responsive, i.e., in real-time, relative to the process being performed, monitored or controlled by the application. For example, an automatic pilot application must respond to input data on changing flight conditions or the position of other aircraft in real-time and responsively to maintain control of the aircraft. It is well-known that the process time constant is typically related to the required real-time response period, measured in units of time. Examples of network based real-time applications include half-duplex applications such as video surveillance and monitoring and all full-duplex applications such as Internet telephony and Internet video-conferencing. Such real-time applications typically cannot use the edge services for performance improvements since real-time control is essential.

Prior art for performing real-time control applications in a distributed computing environment has primarily relied on the use of dedicated networks such as ATM networks. In IP networks QoS enhancements have been proposed for implementation at the network layer. These enhancements are in the form of new network protocols that must be supported by all routers present on a given route. These proposed protocols either reserve resources for certain flows or discriminate between different types of information packets traveling through them. Presently, however, no widespread adoption of these protocols has been observed. A summary of the state-of-the-art in network and application-level QoS solutions is described in a recent technical paper entitled “Theories and Models for Internet Quality of Service” by V. Firoiu, J. Y. Le Boudec, D. Towsley, and Z. L. Zhang, Proceedings of the IEEE, Vol. 90, No. 9, pp. 1565-1591, September 2002.

Another prior art technique is an edge-based framework for flow (or congestion) control technique proposed by Professor S. Kalyanaraman and his students at the Rensselaer Polytechnic Institute (‘RPI’). A reference for this work is a recent PhD dissertation by D. Harrison entitled, “Edge-to-edge Control: A Congestion Avoidance and Service Differentiation Architecture for the Internet”, Department of Computer Science, RPI, May 2002. The thesis advisor for this work was Professor S. Kalyanaraman. This technique attempts primarily to influence IP network congestion from the edges. Hence it is a transport-level solution. It is not an application-level solution and it is not intended to address QoS of real-time applications. Furthermore, it has no predictive components or capabilities.

It should therefore be appreciated that a need exists to provide an application-level, or an edge solution, to control the transport and delivery of media or other application content across a standard, best-effort network Furthermore, it would be desirable for this solution to meet QoS specifications of real-time, as well as non-real-time, applications.

### SUMMARY

The foregoing need is addressed by the present invention. According to one form of the invention, a method and system for actively controlling transport and delivery of content across best-effort networks includes computing expected content bit rate values associated with a distributed application, and expected quality of service (QoS) metrics for the application. Along with the actual measurements that are indicative of the content bit rate and metrics, the expected bit rates and metrics are used to control the bit rate being generated by the application. The expected bit rates and metrics may be based on measured values of previous bit rates and metrics, or their various transformations, as well as previously forecasted bit rates and metrics, or their various transformations. The forecasting of bit rates and metric may be facilitated by the use of an appropriate predictive algorithm. In this manner, active control of content being transported and delivered over best-effort networks is achieved without substantially modifying the core network infrastructure.

In one aspect of the present invention, a method for forecasting the bit rate of content generated by the distributed application includes receiving measurements for the bit rate measured over a finite time horizon, and previously forecasted values for the bit rate. The previously forecasted values are generated responsive to previous measurements. New forecasted values for the bit rate over the horizon are computed responsive to the measurements and the previously forecasted values.

In another aspect of the present invention, a method for forecasting Quality of Service (“QoS”) metrics for a distributed application, includes receiving measurements for the QoS metrics experienced by packets of the application content over a finite time horizon, and previously measured and forecasted values for the metrics and the bit rate. The QoS defines acceptable levels of networked or distributed application performance. New forecasted values for the QoS metrics over the horizon are computed responsive to the measurements and the previously forecasted values.

Other forms, as well as additional aspects, objects and advantages of the invention will become apparent upon reading the following detailed description and upon reference to the accompanying drawings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1A illustrates a schematic of selected elements of an active content control (“ACC”) system in accordance with an embodiment of the present invention.

FIG. 1B illustrates a schematic of selected elements of an active content control (“ACC”) system for multi-cast applications in accordance with an embodiment of the present invention.

FIG. 2 illustrates a block diagram of selected elements of an active content control (“ACC”) system for unicast applications in accordance with an embodiment of the present invention.

FIG. 3A illustrates selected components of an active content controller in accordance with an embodiment of the present invention.

FIG. 3B illustrates a block diagram of selected elements of a bit rate forecasting component in accordance with an embodiment of the present invention.

FIG. 3C illustrates a block diagram of selected elements of a QoS metrics forecasting component in accordance with an embodiment of the present invention.

FIG. 3D illustrates a block diagram of selected elements of an active content control (“ACC”) system for source-side implementation in accordance with an embodiment of the present invention.

FIG. 3E illustrates a block diagram of selected elements of an active content control (“ACC”) system for destination-side implementation in accordance with an embodiment of the present invention.

FIG. 3F illustrates a high-level block diagram for an ACC media content flow control loop for a source-side implementation in accordance with an embodiment of the present invention.

FIG. 4 illustrates a flow diagram of a method for forecasting a bit rate of content generated by an application in accordance with an embodiment of the present invention.

FIG. 5 illustrates a flow diagram of a method for forecasting a QoS metrics of content generated by an application in accordance with an embodiment of the present invention.

FIG. 6 illustrates a flow diagram of a method for controlling a bit rate of content generated by an application in accordance with an embodiment of the present invention.

FIG. 7 is a computer system appropriate for implementing one or more embodiments of the present invention.

### DETAILED DESCRIPTION OF THE PREFERRED EMBODIMENT

In the following detailed description of the preferred embodiments, reference is made to the accompanying drawings illustrating embodiments in which the invention may be practiced. It should be understood, however, that the drawings and detailed description are not intended to limit the invention to the particular form disclosed, but on the contrary, the intention is to cover all modifications, equivalents and alternatives falling within the spirit and scope of the present invention as defined by the appended claims.

The following terminology may be useful in understanding the present invention. It is to be understood that the terminology described herein is for the purpose of description and should not be regarded as limiting.

Media Content—Typically refers to the digital content that is in the form of frames, packets or even bits, which must be processed or utilized by an application in a particular time-sequence and at a specified predetermined rate. Examples of media content include digital audio and video streams.

Content Delivery Networks (CDN)—CDN's are typically overlay networks, which are networks that are overlaid or built on the top of existing networks, e.g. the Internet. CDN's are typically used to reduce network traffic congestion and, as a result, the latency experienced by the media content in client-server distribution models. CDN's are generally effective for delivery and distribution of non-real-time (or cacheable) media or data content.

Open Pluggable Edge Services (“OPES”)—OPES are a new class of services that would be deployed at application-level intermediaries in a network

Packet-switched Networks—These are generally digital networks that operate on the principle of splitting the media content to be delivered into packets and then transporting these packets independently of each other. The sender splits the content, i.e., packetizes it, and the receiver assembles it back together. Packet-switched networks are in contrast to circuit-switched networks, such as the existing telephone networks. Circuit-switched networks typically reserve a path (or connection) between a source and destination for transporting content, and keep the connection open until all content has been transported.

Internet Protocol (IP)—The IP standard, and variations thereof such as IPsec, and IPv6, is the most widely deployed network layer (Layer 3) protocol.

Transmission Control Protocol (“TCP”), User Datagram Protocol (“UDP”)—Two of the popular standards for transport layer (Layer 4) protocols. The TCP protocol typically includes congestion control and is used to transport media content that is not delay-sensitive but needs to be delivered in its entirety, e.g., file transfer. The UDP protocol is typically used to transport media content that is delay-sensitive, e.g. audio or video streams.

IntServ, DiffServ, MPLS—A set of recent network layer protocols proposed for use in enforcing levels of quality-of-service (QoS) in IP networks.

Unicast, Multicast Mode—One-to-one and one-to-many mode of communication.

Voice over IP (“VoIP”)—The transport of voice media content over an IP network rather than a circuit-switched network, such as the telephone system.

Digital Signal Processor (“DSP”)—A computing device that is typically optimized for improved performance of certain operations, such as a Fast-Fourier Transform (“FFT”) processing.

Proportional-Integral-Derivative (“PID”) Controller—A well-known and widely used algorithm for performing control.

Wide Area Networks (“WAN”)—WAN's are typically geographically distributed networks that are characterized by large capacities to carry traffic. WAN's are generally used to connect various metropolitan or local area networks (“LANs”). They are typically heterogeneous, e.g. Internet.

Best-effort Networks—These are packet-switched networks that typically offer connectivity. Generally, no other network service is offered because no network resource is reserved to perform the network services. In a best-effort network, all message packets traveling though the network are treated equally on a first-come-first-serve basis. As a result these networks typically exhibit significant variations in the delay experienced by message packets traveling from a source to a destination. The resulting throughput (or amount of bits transported per unit time) also varies. In general, a best-effort network includes any network that exhibits at least some of the characteristics of the best-effort network described above.

Asynchronous Transfer Mode (ATM) Networks—This is a widely used WAN technology which offers several service classes for differentiation of traffic.

End-to-end (“e2e”) Delay—The cumulative time delay a message packet experiences as it travels between two end-points of a packet-switched network, e.g., from the source sending the packet to the destination receiving the packet.

Delay Jitter—The time variation of the e2e delay.

Packet Loss—These are the message packets dropped (lost or discarded) on their way to a destination as a result of congested routers encountered on their routes.

Throughput—The effective transport rate of an e2e route. In other words, throughput is the amount of media content transported per unit time. This quantity is typically upper bound by the lowest link bandwidth (“BW”) of the route.

Quality-of-Service (QoS)—A set of measurable metrics that determine the acceptability of a network service or an application. For media applications such as audio and/or video this set may consist of metrics such as e2e delay, e2e delay jitter, packet loss, and throughput requirements.

Service Level Agreement (SLA)—Agreements made between service providers and consumers for guaranteed levels of service performance in exchange for variable price structures.

Generally speaking, the present invention describes a method, system, and computer program product to control transport and delivery of media and other application content across a standard best-effort network Embodiments of the invention predict or forecast media content bit rate associated with an application and predict or forecast QoS metrics for the application. The forecasted bit rates and QoS metrics are used to control the bit rate being generated by the application. The forecasted bit rates and QoS metrics may be based on measured values of previous bit rates and QoS metrics as well as previously forecasted bit rates and QoS metrics. The forecasting of bit rates and metrics may be facilitated by an appropriate predictive control algorithm. In this manner, active control of media or application content over a best-effort network is achieved without substantially modifying the core network infrastructure.

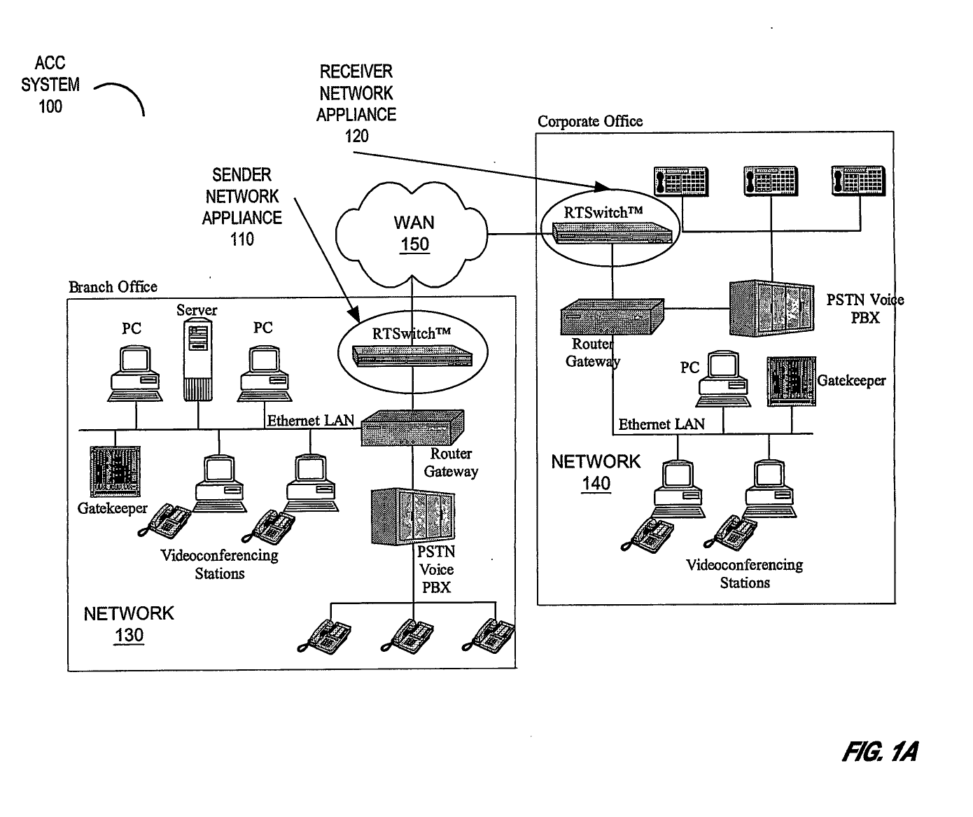

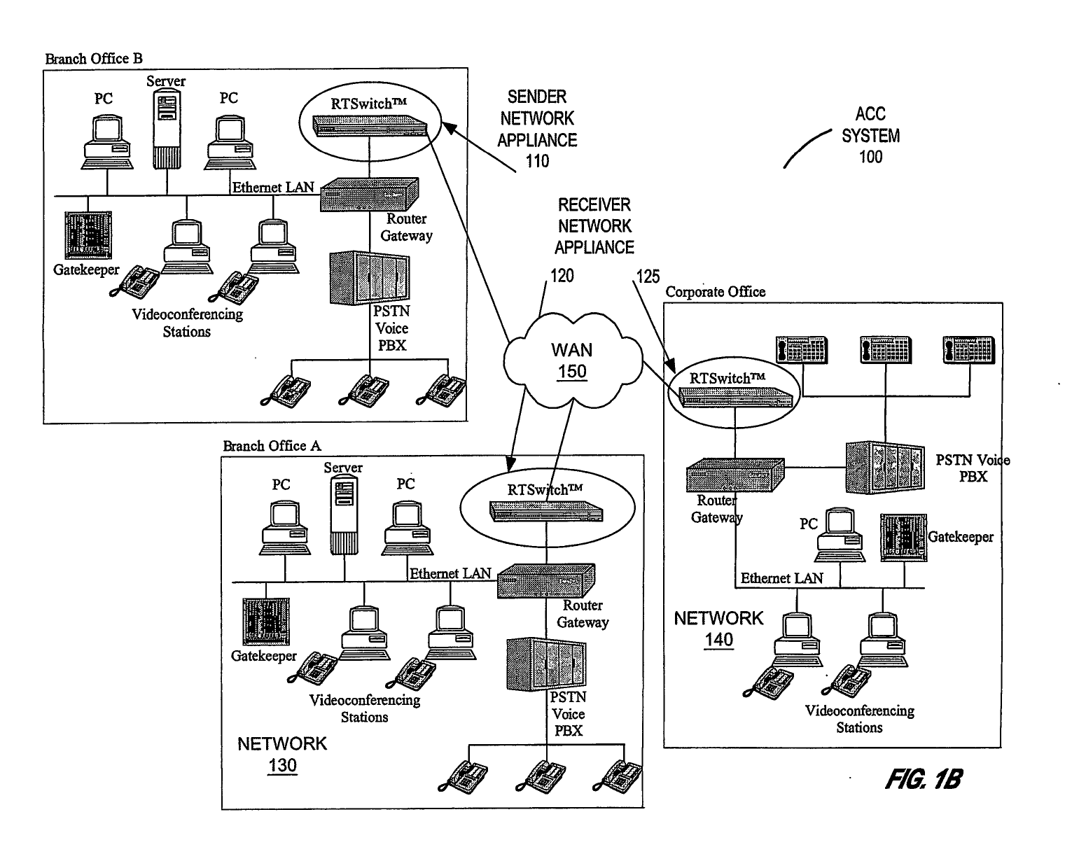

Turning now to the drawings, FIG. 1A is a block diagram of selected elements of an active content control (“ACC”) system 100 according to one embodiment of the invention. In the depicted embodiment, ACC system 100 is based on a best-effort network architecture deploying edge services in a half-duplex, unicast mode. ACC system 100 includes an Open Pluggable Edge Service (“OPES”) application level solution for content control, e.g., to control the QoS metrics of real-time media or data applications that require content delivery over a standard best-effort network, such as the Internet.

In one embodiment, the OPES services are embedded in a computing platform such as a network appliance. For half-duplex, unicast applications, ACC system 100 as depicted in FIG. 1A includes two network appliances. A sender network appliance 110 resides at a sending edge of the network that includes a media application source, e.g., a live video. An optional receiver network appliance 120 resides at a receiving edge of the network that includes the media application destination. Network edge devices such as network appliances 110 and 120 are devices located at the edge of networks 130 and 140, respectively, that connect the edge router or gateway of LANs 130 and 140 to a WAN 150.

Sender network appliance 110 receives media content from one or more sources. In one embodiment, sender network appliance 110 receives media content streams or flows associated with a plurality of sources that are to be delivered to corresponding destinations, with each media content stream having a single source and a single destination. ACC system 100 manipulates the media content streams flowing out of network appliance 110 to control the QoS metrics of the corresponding real-time media or data application. In one embodiment, ACC system 100 deploys predictive flow control techniques to control the QoS metrics.

In full-duplex applications, the media application source and the destination have similar roles. The sending and/or receiving of media or other application content may be independent of each other and may occur concurrently. In this mode, network appliances 110 and 120 may be programmed to perform sending and receiving functions. For example, sender network appliance 110 also functions as a receiver network appliance, and similarly, receiver network appliance 120 also functions as a sender network appliance.

Referring to FIG. 1B, a block diagram of selected elements of ACC system 100, according to an embodiment of the invention is presented. In this embodiment, ACC system 100 is based on a best-effort network architecture deploying edge services in a multicast mode. For multicast applications, there are multiple destinations spread across one or more networks. The block diagram shown includes three network appliances located at the edge of three LANs. Sender network appliance 110 resides at a sending edge of the network that includes the media application source. A receiver network appliance resides at a receiving edge of each corresponding network that includes the media application destination. Two receiver network appliances 120, 125 are shown corresponding to branch office ‘A’ network 130 and corporate network 140.

In addition to the network appliance embodiment, a number of possible architectural variations of this invention are also contemplated, as follows:

1) Embedded QoS control in encoders/decoders is a new generation of encoders/decoders (or codecs) designed to vary the generated bit-rate using predictive network QoS metrics and “look-ahead” source traffic information. The information used by such encoders/decoders is in addition to the information widely used by current generation of encoders/decoders for quantization and compression.

2) Active QoS control as an application middleware service.

3) Active QoS control embedded in edge-routers.

4) Multi-peer (or multicast) implementations, with the same possible options as outlined above in the case of the peer-to-peer (or unicast) implementations.

5) Implementation that is in combination with the various route-control architectures currently promoted by various vendors.

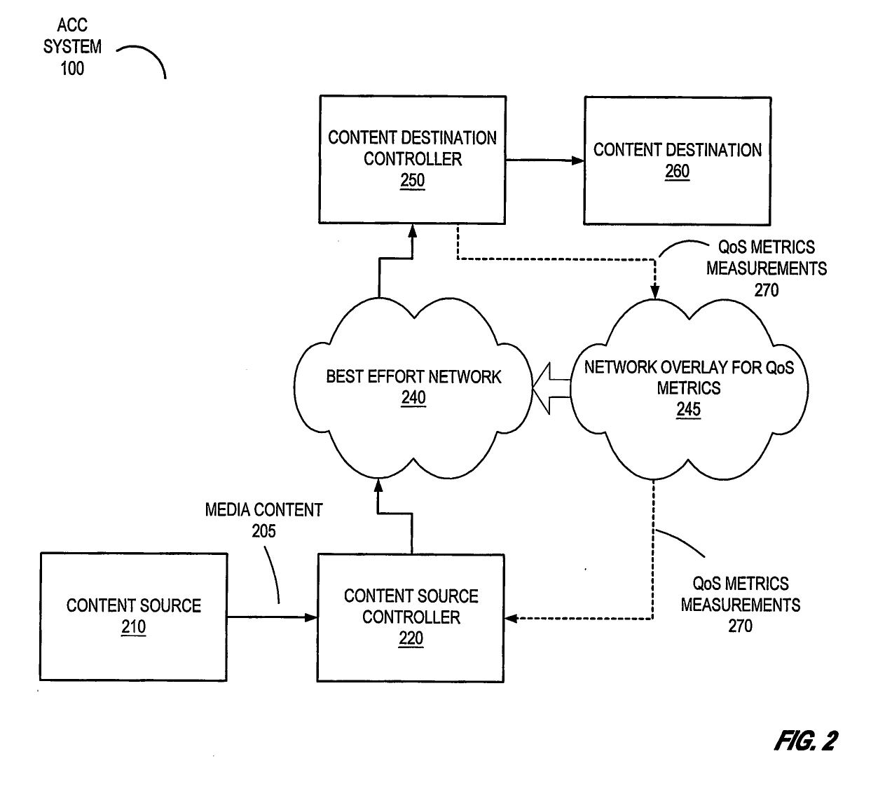

Further details of the techniques to control delivery of media content across the best-effort network are illustrated in FIGS. 2-7.

FIG. 2 is a block diagram illustrating selected components of an active content control system 100, according to an embodiment emphasizing use of the invention in conjunction with half-duplex, unicast applications. A content source 210 provides digital media content 205 in the form of frames, packets or even bits that are generated by an application. The application may include real-time media and/or data applications, such as live audio and/or video streams. In one embodiment, the media content 205, also simply referred to as the content 205 may be generated by any distributed application. Examples of half-duplex applications include video surveillance over the Internet, and full-duplex applications include Voice over IP (VoIP), videoconferencing and gaming software.

A best-effort network 240 delivers the media content 205, in accordance with no pre-defined QoS metrics, to a corresponding destination, e.g., content destination 260. An ACC controller, such as a content source controller (or a send rate controller) 220 controls the send rate of the media content 205 to be in compliance with the QoS metrics for the application. Content source controller 220 receives measurement information describing QoS metrics from a QoS overlay network 245. The QoS overlay network 245 is an overlay network, similar to a CDN, which is built on the top of the existing best-effort network 240.

Information describing the QoS metrics such as an e2e delay of network 240 is collected from various destination devices corresponding to various sources. Computing a difference in clock synchronized time stamp values collected at a destination and source location may be used to measure the e2e delay for each flow. Content source controller 220 performs control action by receiving measurement information describing QoS metrics and content source bit rate, forecasting content source bit rate and QoS metrics, comparing the received measurement information with the QoS metrics required for the application, and adjusting the send rate of the content source received to be in compliance with the required QoS metrics. The control algorithm deployed within content source controller 220 may vary from a simple PID algorithm to a more advanced model predictive control (“WPC”) algorithm. The QoS metrics required for a given application may be pre-defined, may be programmed, may be defined interactively on a display screen of a computer, or adaptively selected by the application. A summary of the state-of-the-art in available packet measurement techniques and tools is described in a technical paper entitled “Internet Performance Monitoring” by T. M. Chen and L. Hu, Proceedings of the IEEE, Vol. 90, No. 9, pp. 1592-1603, September 2002.

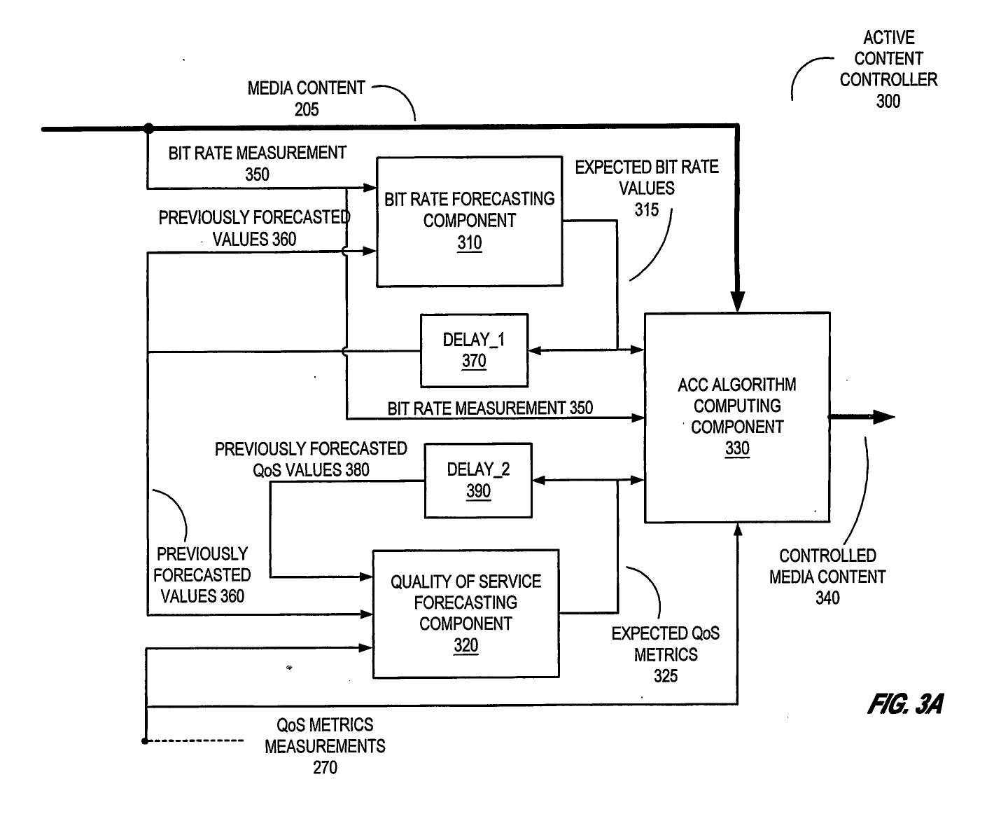

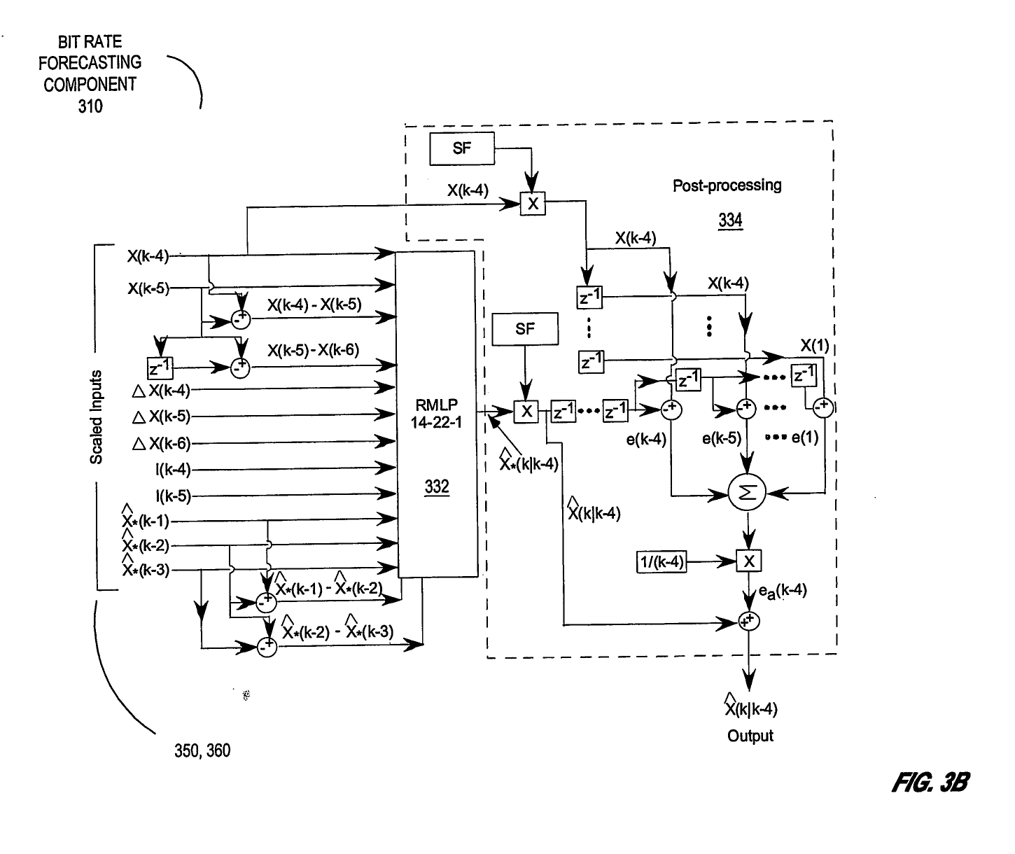

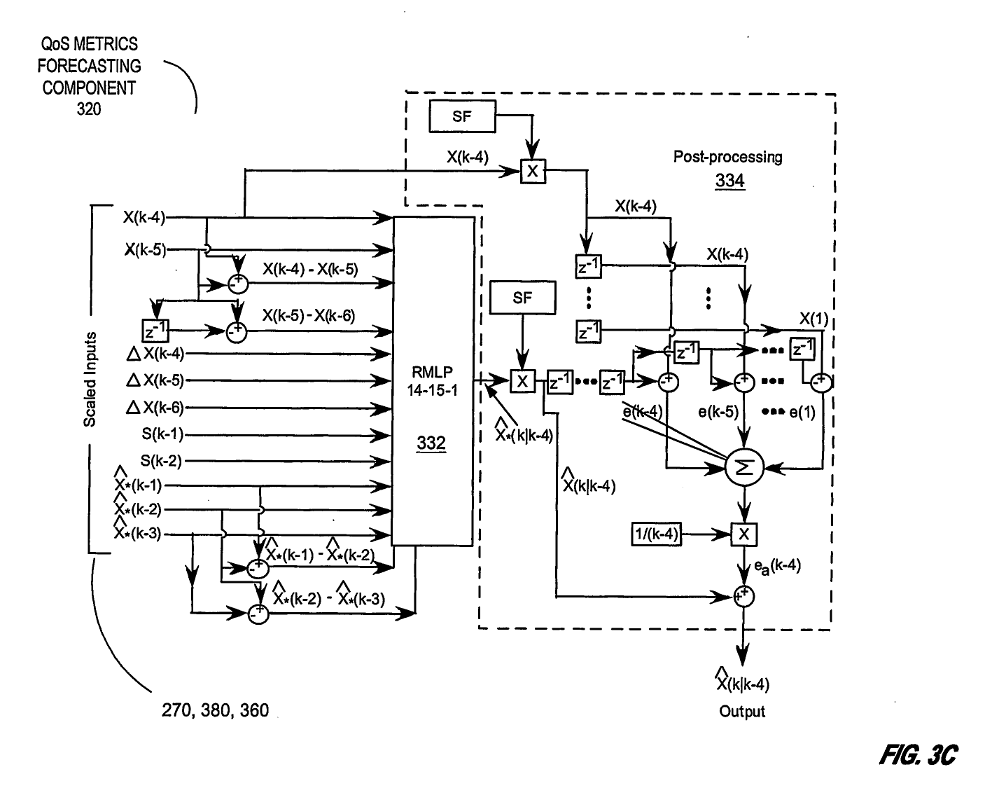

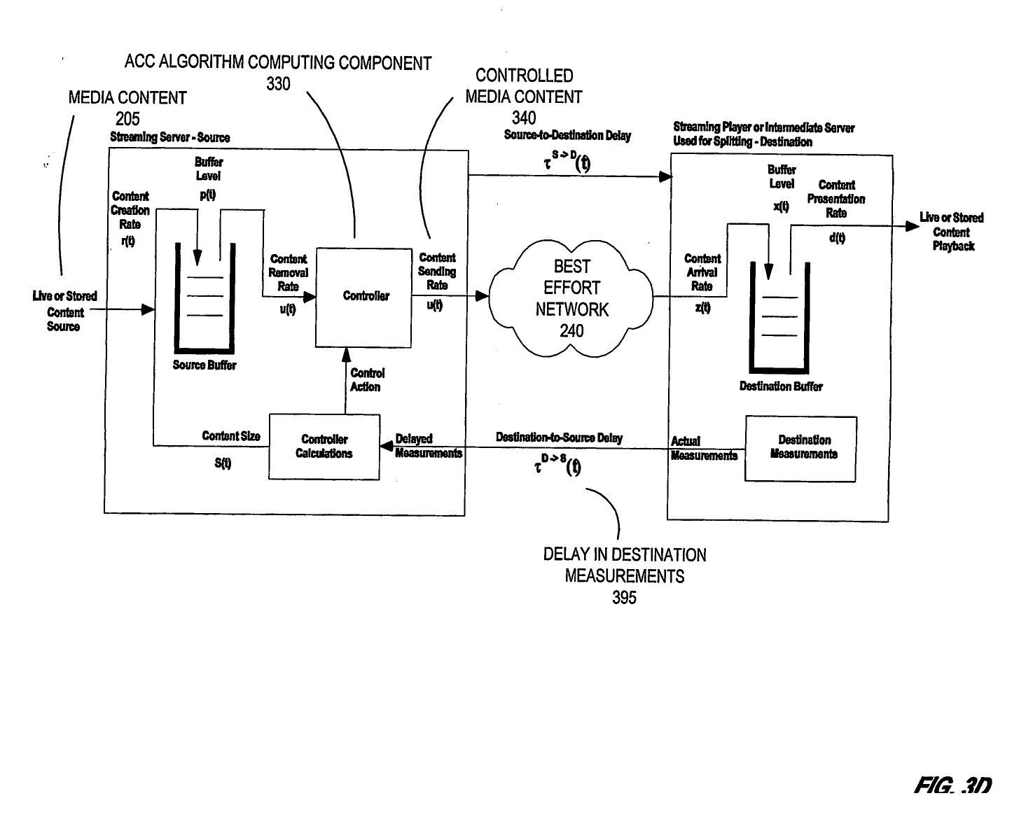

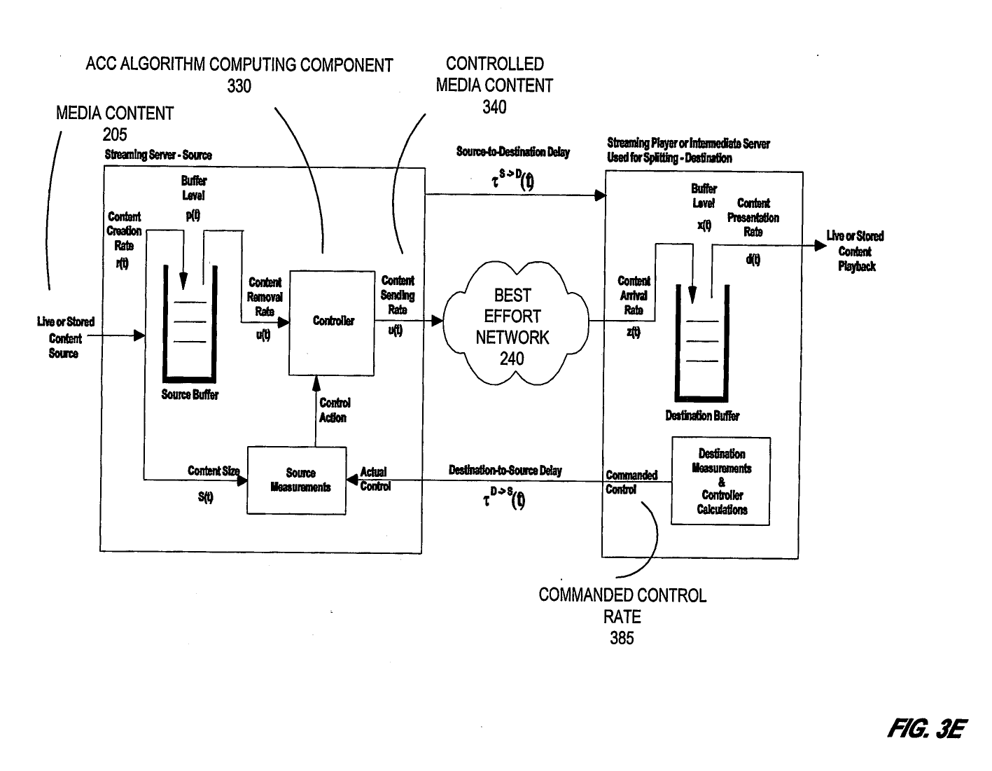

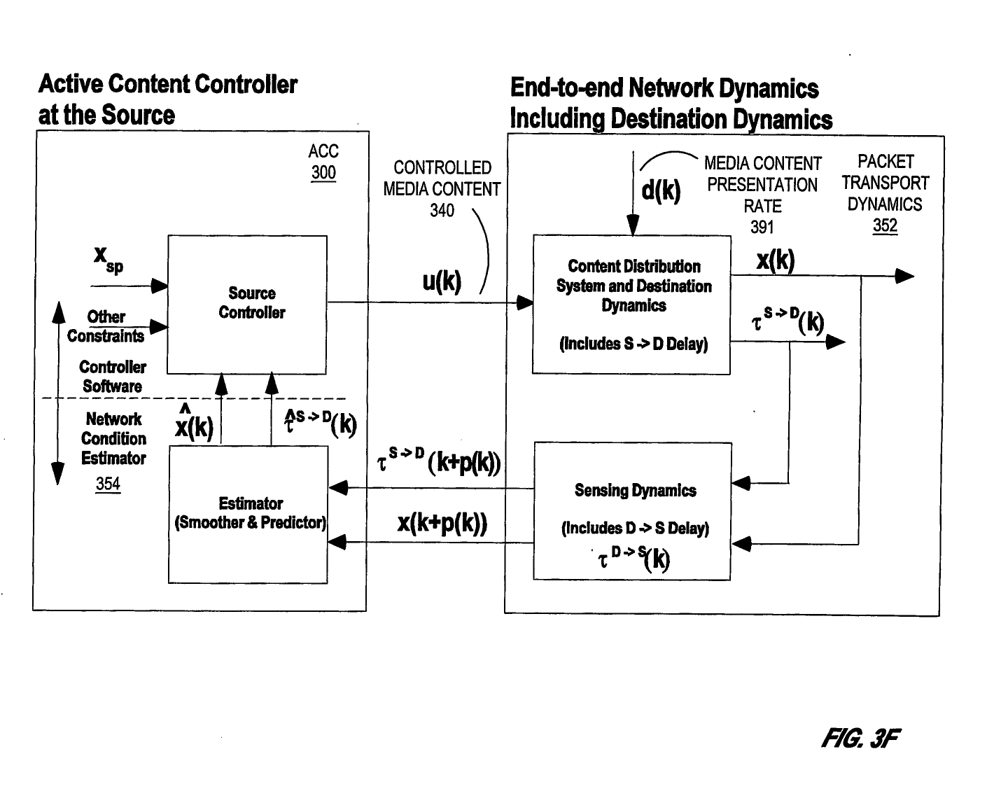

In one embodiment, the ACC controller functions may be performed in a content destination controller 250 (or receive rate controller) rather than content source controller 220. In this embodiment, content destination controller 250 still controls source media content 205 send rate to be in compliance with the required QoS metrics, though the ACC controller implementation is at the destination. In one embodiment, the ACC controller functions may include predictive and control components at content source controller 220 and/or content destination controller 250. Further details of the components of the content source controller 220 and the content destination controller 250 are illustrated in FIGS. 3-5.

In one embodiment, in addition to the predictive and control components at the source, the application-level QoS control solution for halfduplex applications may also include additional components such as:
1) packet time-stamp measurement components and clock synchronization at the source and destination to measure e2e delay,
2) a scheduling component at the source for variable packet inter-departure time, packet sequencing and packet dropping, or for sending multiple packets simultaneously with constant or variable inter-departure times in burst mode,
3) a bandwidth allocation component at the source,
4) a media synchronization component at the destination, and
5) a platform component such as a real-time operating system and processor units at the source.

In one embodiment, the application-level QoS control solution for full-duplex applications may include additional components such as:
1) predictive components at the source and destination, for forecasting source and destination traffic level and network QoS metrics,
2) ACC control components at the source and destination for determining adjustments needed to the sending bit-rate,
3) scheduling components at the source and destination for variable packet inter-departure time and packet dropping, or for sending multiple packets simultaneously with constant or variable inter-departure times in burst mode,
4) bandwidth allocation components at the source and destination,
5) media synchronization components at the source and destination, and
6) platform components such as a real-time operating system and processor units at the source and destination.

FIG. 3A is a block diagram showing selected components of an active content controller 300 according to an embodiment of the invention. In this embodiment, ACC controller 300 provides a technique to control the media content send rate to meet the QoS metrics for the application. ACC controller 300 may be implemented as within content source controller 220 and/or within content destination controller 250 as depicted in FIG. 2. ACC controller 300 as shown may be implemented within content source controller 220 that includes:
1) a bit rate forecasting component (or module) 310 that computes an expected bit rate for media content of the application based at least partially on the input received from the content source,
2) a QoS metrics forecasting component (or module) 320 that computes expected QoS metrics for the application based at least partially on the input received from the QoS measurements, and
3) an ACC algorithm computing component (or module) 330 that computes a controller output 340 to control the media content send rate. The controller output 340 is computed at least partially on the inputs received from the bit rate forecasting module and the QoS metrics forecasting module. The controller output 340 is a modified (or controlled) version of the original media content 205, where such modifications are intended to satisfy the distributed application QoS specifications. In one embodiment, the ACC algorithm computing module 330 may also incorporate other encoder functions, such as quantization and/or compression.

In one embodiment, the bit rate forecasting may be performed independently outside of ACC controller 300 and the results of the computation, e.g., the expected bit rate for the media content, may be sent to ACC controller 300. For example, the bit rate forecasting may be performed independently outside of content source controller 220 depicted in FIG. 2. Similarly, in another embodiment, the QoS metrics forecasting may be performed independently outside of ACC controller 300 and the results of the computation, e.g., the expected QoS metrics may be sent to ACC controller 300. For example, the QoS metrics forecasting may be performed independently outside of content source controller 220 depicted in FIG. 2.

Additional details of bit rate forecasting component 310, QoS metrics forecasting component 320, and ACC algorithm computing component 330 are described below.

In one embodiment, bit rate forecasting component 310 forecasts the source traffic bit-rate over a finite time horizon. Prediction of the bit rate (or the expected bit rate) is performed in terms of average bits/sec, in terms of individual frame sizes, or in terms of packet sizes. The algorithm to arrive at the expected value may be based on well-known single-step-ahead or multi-step-ahead prediction algorithms. For example, the technical paper entitled ‘Multi-Step-Ahead Prediction in Complex Process Systems using Dynamic Recurrent Neural Networks, Parlos, Alexander G., 0. T. Rais, and A. F. Atiya, Neural Networks, Vol. 13, No. 7, pp. 765-786, September 2000, describes one such predictive algorithm and is incorporated herein by reference.

Bit rate forecasting component 310 receives, typically by a software process, two inputs:
i) bit rate measurements 350 indicative of the bit rate measured over a finite time horizon, and
ii) previously forecasted bit rate values 360.
   In one embodiment, bit rate measurements 350 may include current and previous (or delayed) bit rate measurements and their various transforms (such as their scaled values or their moving averages). In one embodiment, previously forecasted bit rate values 360 may include current and previous (or delayed) bit rate forecasts and their various transforms (such as their scaled values or their moving averages). Thus, the expected, predicted, or forecasted bit rates may be based on measured values or various transformations of previous bit rates as well as previously forecasted bit rates or various transformations of previously forecasted bit rates.

Previously forecasted bit rate values 360 are generated by the software process responsive to previous measurements for the bit rate, e.g., delay_1 370 generates the previously forecasted values 360 in response to expected bit rate values. Bit rate forecasting component 310 computes new forecasted values (also referred to as expected values) 315 for the bit rate over the horizon responsive to the measurements and the previously forecasted values. The computation includes well-known single-step-ahead or multi-step-ahead prediction algorithms including linear adaptive prediction and forecasting algorithms. For example, the technical paper entitled ‘Neuro-Predictive Process Control Using On-line Controller Adaptation’, Parlos, Alexander G., S. Parthasarthy, and A. F. Atiya, IEEE Transactions on Control Systems Technology, Vol. 9, No., 5, pp. 741-755, September 2001, describes one such predictive algorithm and is incorporated herein by reference.

FIG. 3B illustrates a block diagram of bit rate forecasting component 310, according to an embodiment of the invention. Bit rate measurements 350 including current and previous (or delayed) bit rate measurements and their various transforms (such as their scaled values or their moving averages) are combined with previously forecasted bit rate values 360 including current and previous (or delayed) bit rate forecasts and their various transforms (such as their scaled values or their moving averages) to form the input to the bit rate forecasting component 310, denoted ‘Scaled Inputs’ in FIG. 3B. These inputs are processed by neural network unit, such as a Recurrent Multilayer Perceptron (“RMLP”) 332, designed to predict or forecast multi-step-ahead values of the source bit rate. The technical paper by Parlos, Rais and Atiya referenced above provides one method for designing an RMLP unit for forecasting multi-step-ahead values of variables. The multi-step-ahead values generated by the RMLP neural network unit are post-processed as shown in FIG. 3B within a dashed sub-block designated as ‘Post-processing’ 334, using various well-known signal processing techniques to generate the expected bit rate values 315 designated as ‘Output’ in FIG. 3B.

To re-iterate, media source bit-rate forecasting component 310 utilizes a combination of previous measurements and predictions of source traffic level and their various transformations, and, well known single-step-ahead or multi-step-ahead prediction algorithms, including linear adaptive prediction and forecasting algorithms to generate the expected bit rate 315 for media content. Being an edge solution, the media source bit-rate forecasting component is advantageously independent of the compression algorithms and other encoder details, and is independent of the underlying network architecture and protocol details of the network layers 1-4. In one embodiment, the edge solution may be incorporated within an encoder to further improve the efficiency of algorithm implementation.

In one embodiment, QoS metrics forecasting component 320 forecasts the values for the QoS metrics over a finite time horizon. In one embodiment, the expected QoS metrics may be forecast in terms of an e2e delay experienced by packets and (indirectly) the anticipated packet losses. Additional predictions of e2e delay variations and throughput may also be performed. Prediction is performed in terms of an e2e delay or e2e delay change, either per packet or as an average for a number of packets within a finite window. The algorithm to arrive at the expected values may be based on well known single-step-ahead or multi-step-ahead prediction algorithms. For example, the technical paper entitled ‘Identification of the Internet End-to-end Delay Dynamics Using Multi-Step Neuro-Predictors’, Parlos, Alexander G., International Joint Conference on Neural Networks, Honolulu, Hi., May 2002, describes one such predictive method for forecasting QoS metrics and is incorporated herein by reference.

The QoS metrics forecasting component 320 receives, typically by a software process, a plurality of inputs:
i) measurements of the network performance experienced by a packet of the media content identified herein as QoS metrics measurements 270,
ii) previously forecasted QoS metrics 380, and
iii) previously forecasted bit rate values 360 for bit rates of the media content.

In one embodiment, QoS metrics measurements 270 may include current and previous (or delayed) metrics measurements and their various transforms (such as their scaled values or their moving averages). In one embodiment, previously forecasted bit rate values 360 and previously forecasted QoS metrics 380 may include current and previous (or delayed) forecasts and their various transforms (such as their scaled values or their moving averages). Thus, the expected, predicted, or forecasted QoS metrics may be based on measured values of the QoS metrics as well as previously forecasted bit rates and metrics. In one embodiment, additional inputs for the time-of-the-day, and the day-of-the-week may also be received to improve the forecasting process.

The previously forecasted bit rate values 360 and QoS metrics 380 are generated by the software process responsive to earlier bit rate and QoS measurements, delay 2 390 generates the previously forecasted QoS metrics 380 in response to expected QoS values. QoS metrics forecasting component 320 computes new forecasted or expected values for QOS metrics 325 over the horizon responsive to the measurements and the previously forecasted values. The computation includes well-known single-step-ahead or multi-step-ahead prediction algorithms including linear adaptive prediction and forecasting algorithms, such as the multi-step neuro-predictor algorithm cited earlier.

FIG. 3C illustrates a block diagram of QoS metrics forecasting component 320, according to an embodiment of the invention. QoS metrics measurements 270 including current and previous (or delayed) QoS metrics measurements and their various transforms (such as their scaled values or their moving averages) are combined with previously forecasted bit rate values 360 and previously forecasted QoS metrics 380 including their various transforms (such as their scaled values or their moving averages) to form the input to the QoS metrics forecasting component 320, denoted ‘Scaled Inputs’ in FIG. 3C. These inputs are processed by neural network unit, such as Recurrent Multilayer Perceptron (RMLP) 332, designed to predict or forecast multi-step-ahead values of the various QoS metrics, such as e2e delay or e2e delay jitter. The technical paper by Parlos, Rais and Atiya referenced above provides one method for designing an RMLP unit for forecasting multi-step-ahead values of variables. The multi-step-ahead values generated by the RMLP neural network unit are post-processed as shown in FIG. 3C within dashed sub-block designated as ‘Post-processing’ 334, using various well-known signal processing techniques to generate the expected QoS metrics values 325 designated as ‘Output’ in FIG. 3C.

To re-iterate, QoS metrics forecasting component 320 utilizes a combination of past measurements and predictions of network e2e delay and source send rates and their various transforms, and, well known single-step-ahead or multi-step-ahead prediction algorithms, including linear adaptive prediction and forecasting algorithms, to generate expected QoS metrics. Being an edge solution, the QoS metrics forecasting component 320 is advantageously based on existing network standards, is independent of the compression algorithms and other encoder details, is independent of the underlying network architecture and is independent of protocol details of the network layers 1-4. In one embodiment, the edge solution may be incorporated within an encoder to further improve the efficiency of algorithm implementation.

QoS metrics forecasting component 320 may thus be used to predict expected QoS metrics such as e2e delays, e2e delay variations, fraction of packet losses, and application throughput (per flow or aggregate).

In one embodiment, ACC algorithm computing component 330 controls, adjusts or throttles the required per-flow (or even aggregate) bit-rate to meet the applicable QoS specifications. As described earlier, ACC algorithm computing component 330 receives, typically by a software process:
i) measured bit rate 350 and expected bit rate 315 for the application generated by bit rate forecasting component 310,
ii) measured QoS metrics 270 and expected QoS metrics 325 for the application generated by QoS metrics forecasting component 320.

ACC algorithm computing component 330 generates controller output 340 based at least partially on expected bit rate 315, measured bit rate 350, expected QoS metrics 325, measured QoS metrics 270 and media content 205 source. The send rate of the content source is controlled based at least partially on these parameters. In one embodiment, ACC algorithm computing component 330 implements the computed variable bit-rate by scheduling single packets at variable inter-departure times, by scheduling multiple simultaneous (or bursts of) packets at fixed inter-departure times, or by preventing certain packets from departing at all, e.g., by delaying them or dropping them. This technique of controlling has advantageously an indirect positive impact on network congestion since, by delaying or even dropping packets at the edges rather than the network core the effects of network congestion are mitigated.

The computation of expected bit rate 315 and expected QoS metrics 325 may include well-known algorithms such as a PID algorithm augmented with predictive information, inverse-delay control with predictive information, model-predictive control, other linear predictive or non-predictive algorithms and the neuro-predictive control algorithm cited earlier.

Being an edge solution, ACC algorithm computing component 330 is advantageously decentralized, and scalable to accommodate a large number of simultaneous flows. Component 330 compensates for anticipated e2e delays and e2e delay variations by throttling the source send rate of each flow. Additionally, component 330 indirectly controls the packet loss rate thereby advantageously reducing losses in unreliable protocols, such as UDP, and reducing retransmissions in reliable protocols, such as TCP, thereby improving flow throughput.

As one skilled in the art would appreciate, any or all of ACC controller 300 components depicted in FIG. 3A may be implemented as hardware, firmware, and/or software depending on the performance requirements of the application. For example, components 310, 320 and 330 may be implemented as application specific integrated chips (“ASIC”) in an embodiment. In another embodiment, components 310, 320 and 330 may be implemented in network appliance 110 that includes hardware and software components. Thus, receiving inputs for components 310, 320 and 330 may deploy hardware and/or software means.

FIGS. 3D and 3E are block diagrams illustrating selected elements of ACC system 100, according to an embodiment of the invention. Specifically, FIGS. 3D and 3E depict two embodiments of active content control system 100 described in FIG. 2. FIG. 3D depicts a source-side implementation embodiment where all control calculations are performed at the source, and ACC controller 300 resides at the source. In this embodiment, there is a delay associated with destination measurements 395. FIG. 3E depicts a destination-side implementation embodiment where all control calculations are performed at the destination, but ACC controller 300 still resides at the source. In this embodiment, there is a delay associated with commanded control rate 385. In both embodiments the content stream (or bit rate) is controlled by the source.

FIG. 3F illustrates a high-level block diagram for an ACC media content flow control loop for a source-side implementation embodiment illustrated in FIG. 3D. In FIG. 3F, a packet transport dynamics 352 block includes the processes associated with packet measurements. The left-hand-side of the block diagram depicts the various active QoS control processes embedded in the ACC controller 300. The e2e delays, and possibly other destination measurements such as destination buffer level, are received by the source in a delayed manner. This information is used to forecast future values of these QoS metrics variables, denoted as ‘Network Condition Estimator’ 354 in FIG. 3F. The source controller receives the measured and forecasted QoS metrics information, along with distributed application QoS specifications, source media bit rate measurements and forecasted values, and other network constraints, such as available aggregate or per-flow network bandwidth. This information is used by the source controller to compute the source controller output, i.e., the controlled media send rate 340.

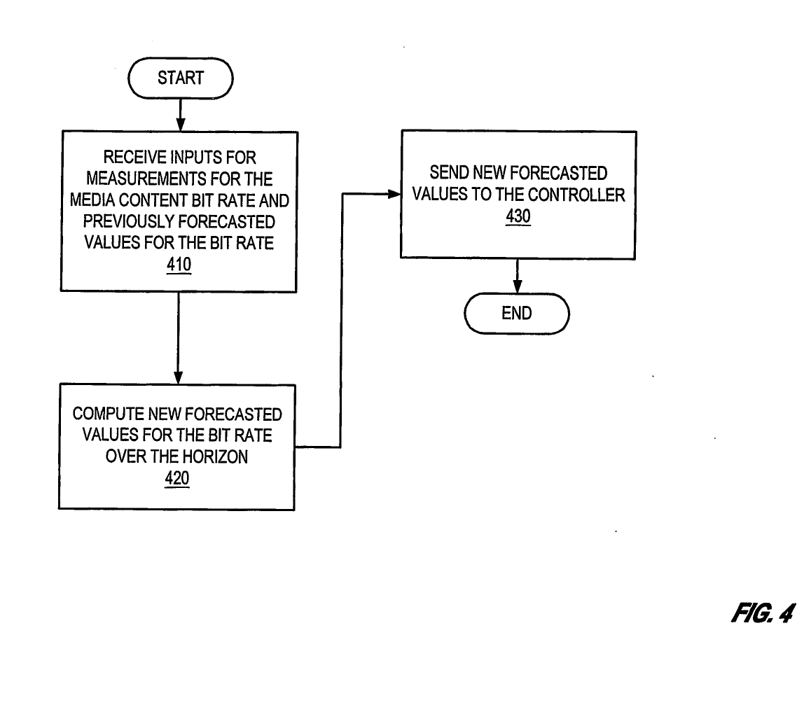

Referring to FIG. 4, a flow diagram of a method for forecasting a bit rate of content generated by an application where the content is being transported over a best-effort network is illustrated. Initially, a software process receives (block 410) inputs including:
i) bit rate measurements indicative of the measured or actual bit rate over a finite time horizon, and
ii) previously forecasted values for the bit rate, the previously forecasted values being generated by the software process responsive to previous measurements. As described earlier, a hardware process may be used to receive the inputs, in one embodiment.

The software process then computes (block 420) new forecasted values for the bit rate over the horizon, responsive to the measurements and the previously forecasted values. The new forecasted values are sent (block 430) to a controller, the controller controlling the bit rate in response to the new forecasted values.

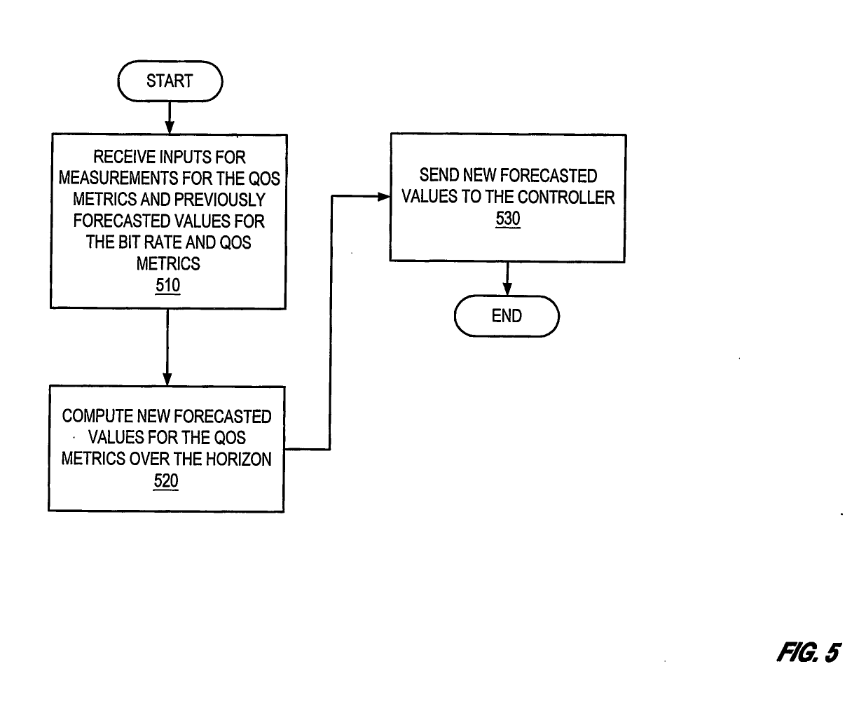

Referring to FIG. 5, a flow diagram of a method for forecasting quality of service (QoS) metrics of an application that generates content being transported by a best-effort network is illustrated. The QoS defines levels of acceptable network performance for a particular distributed application. A software process receives (block 510) inputs including:
i) QoS metrics measurements 270 indicative of the actual network performance experienced by a packet of the media content,
ii) previously forecasted QoS metrics 380, the previously forecasted QoS metrics being generated by the software process responsive to previous measurements, and
iii) previously forecasted bit rate values 360 for bit rates of the media content, the previously forecasted bit rate values 360 being generated by the software process responsive to previous bit rate measurements. As described earlier, a hardware process may be used to receive the inputs, in one embodiment.

The software process, responsive to the measurements and the previously forecasted values of QoS metrics and bit rate, computes (block 520) new forecasted values for the QoS metrics 325. The new forecasted values 325 are sent (block 530) to a controller, the controller controlling the bit rate in response to the new forecasted values.

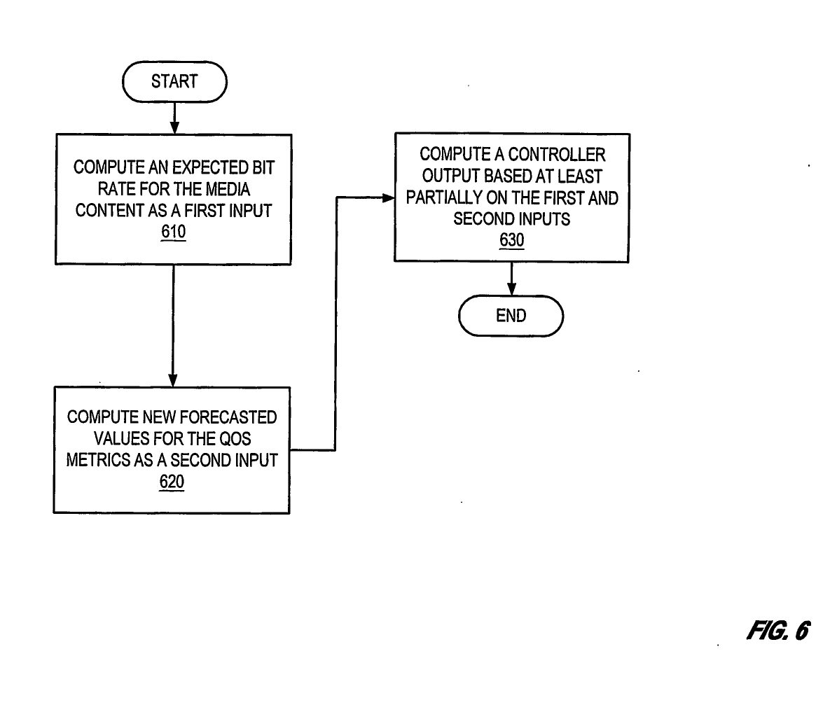

Referring to FIG. 6, a flow diagram of a method for controlling a bit rate of content being generated by an application, the content being transported over a best-effort network is illustrated. An expected bit rate for content 315 generated by the application is computed (block 610), and a first input indicative of the expected bit rate is generated. Expected quality of service (QoS) metrics 325 for the networked application are computed (block 620). The QoS metrics define acceptable levels of network performance that is required by the application. A second input indicative of the expected QoS metrics is generated in response to the computation. The controller output 340 is computed (block 630) based at least partially on the first and second inputs. The send bit rate may be based at least partially on the controller output. As described earlier, the computing described in blocks 610 and 620 may be performed outside of the controller. In this embodiment, the controller, as described in block 630, may receive values for the first and second inputs.

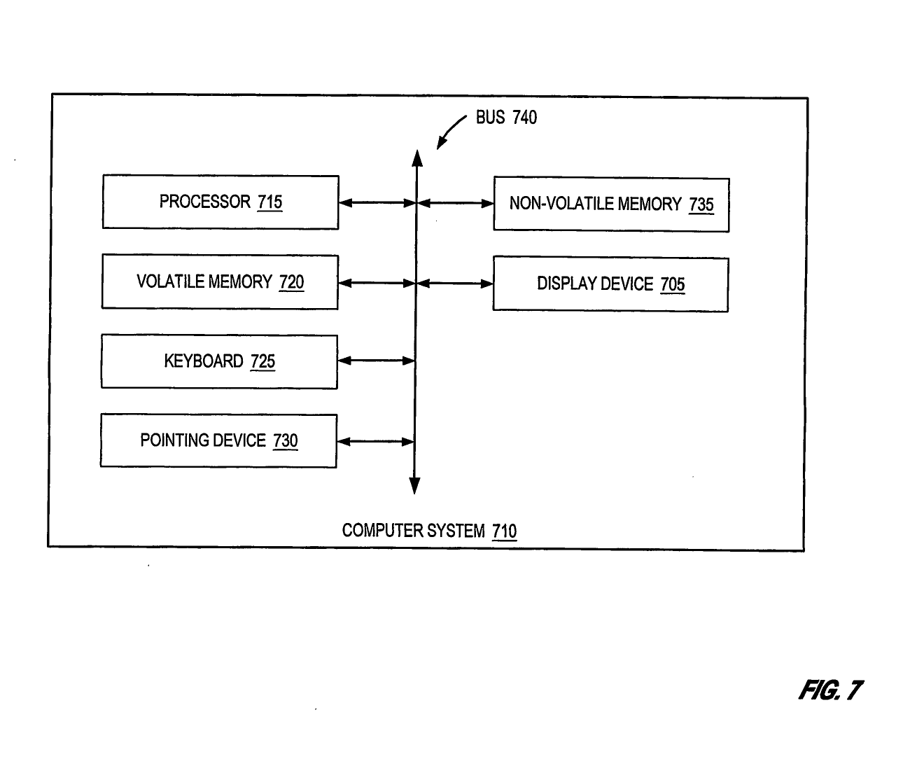

Referring now to FIG. 7, a computer system 710 is shown that is generally applicable for the various embodiments described. The system 710 includes a processor 715, a volatile memory 720, e.g., RAM, a keyboard 725, a pointing device 730, e.g., a mouse, a nonvolatile memory 735, e.g., ROM, hard disk, floppy disk, CD-ROM, and DVD, and a display device 705 having a display screen. Memory 720 and 735 are for storing program instructions, which are executable by processor 715 to implement various embodiments of a method in accordance with the present invention. The memory 720 and 735 may be used to store portions of the time-indexed data sets. Components included in system 710 are interconnected by bus 740. A communications device (not shown) may also be connected to bus 740 to enable information exchange between system 710 and other devices such as other computer systems via a network such as the Internet.

In various embodiments system 710 takes a variety of forms, including a personal computer system, client/server system, mainframe computer system, parallel processing computer system, workstation, digital signal processor (DSP), Internet appliance, PDA, an embedded processor with memory, etc. That is, it should be understood that the term “computer system” is intended to encompass any device having a processor that executes instructions from a memory medium.

The memory medium preferably stores instructions (also known as a “software program”) for implementing various embodiments of a method in accordance with the present invention. In various embodiments the one or more software programs are implemented in various ways, including procedure-based techniques, component-based techniques, and/or object-oriented techniques, among others. Specific examples include XML, C, C++, Java and Microsoft Foundation Classes (MFC).

The description of the present embodiment has been presented for purposes of illustration, but is not intended to be exhaustive or to limit the invention to the form disclosed. Many modifications and variations will be apparent to those of ordinary skill in the art. To reiterate, the embodiments were chosen and described in order to best explain the principles of the invention, the practical application, and to enable others of ordinary skill in the art to understand the invention.

Various other embodiments having various modifications may be suited to a particular use contemplated, but may be within the scope of the present invention. For example, those of ordinary skill in the art will appreciate that the hardware and methods illustrated herein may vary depending on the implementation. Also, while the present invention has been described as a software process, those of ordinary skill in the art will appreciate that hardware and/or firmware implementation may be a preferred option depending on application requirements. Additionally, it is important to note that while the present invention has been described in the context of a computer system having a processor and memory, those of ordinary skill in the art will appreciate that the processes of the present invention are capable of being distributed as computer readable medium of instructions in a variety of forms and that the present invention applies equally regardless of the particular type of signal bearing media actually used to carry out the distribution. Examples of computer readable media include recordable-type media such a floppy disc, a hard disk drive, a RAM, CD-ROM, CD-RW, DVD and transmission-type media such as digital and analog communications links.

To reiterate, many additional aspects, modifications and variations are also contemplated and are intended to be encompassed within the scope of the following claims. Moreover, it should be understood that in the following claims, actions are not necessarily performed in the particular sequence in which they are set out.

1. A method for forecasting a bit rate of content generated by a distributed application, the content being transported over a best-effort network, the method comprising:
receiving, by a software process:
i) measurements for the bit rate measured over a finite time horizon,
ii) previously forecasted values for the bit rate, the previously forecasted values being generated by the software process responsive to previous measurements; and
computing, by the software process responsive to the measurements and the previously forecasted values, new forecasted values for the bit rate over the horizon.

2. The method of claim 1, wherein the new values forecasted are computed as an average number of bits per second.

3. The method of claim 1, wherein the new values forecasted are output as an individual message frame or packet having a variable size.

4. The method of claim 1, wherein the software process includes at least one prediction and forecasting algorithm.

5. The method of claim 4, wherein the at least one algorithm is single-step-ahead or multi-step-ahead.

6. The method of claim 4, wherein the at least one algorithm is linear.

7. The method of claim 4, wherein the at least one algorithm is non-linear.

8. The method of claim 1, comprising:
sending the new forecasted values to a controller, the controller controlling the bit rate in response to the new forecasted values.

9. The method of claim 1, wherein the forecasting of the bit rate is independent of quantization and compression algorithms included in an encoder, the encoder being included in a source generating the content.

10. The method of claim 1, wherein the forecasting of the bit rate is performed in an encoder, the encoder being included in a source for the content.

11. A method for forecasting Quality of Service (“QoS”) metrics of a distributed application, the application generated content being transported over a best-effort network, the QoS defining acceptable levels of network performance, the method comprising:
receiving, by a software process:
i) measurements for the QoS metrics, experienced by a packet of the content over a finite time horizon,
ii) previously forecasted QoS metrics, the previously forecasted QoS metrics being generated by the software process responsive to previous measurements,
iii) previously forecasted bit rate values for bit rates of the content, the previously forecasted bit rate values being generated by the software process responsive to previous bit rate measurements; and
computing, by the software process responsive to the measurements and the previously forecasted QoS metrics and bit rate values, new forecasted values for the QoS metrics over the horizon.

12. The method of claim 11, comprising:
receiving, by the software process, iv) a real-time input describing time and day information; and
re-computing the new forecasted values in response to receiving the measurements, the previously forecasted QoS metrics and bit rate values and the real-time input.

13. The method of claim 11, wherein the new values forecasted for the QoS metrics are measured average quantities over the horizon.

14. The method of claim 11, wherein the new values forecasted for the QoS metrics are applicable for each packet of information included in the content.

15. The method of claim 11, wherein the software process includes at least one prediction and forecasting algorithm.

16. The method of claim 15, wherein the at least one algorithm is single-step-ahead or multi-step-ahead.

17. The method of claim 15, wherein the at least one algorithm is linear.

18. The method of claim 15, wherein the at least one algorithm is non-linear.

19. The method of claim 11, comprising:
sending the new forecasted values to a controller, the controller controlling the bit rate in response to the new forecasted values.

20. The method of claim 11, wherein the forecasting of the QoS metrics is independent of quantization and compression algorithms included in an encoder, the encoder being included in a source generating the content.

21. The method of claim 11, wherein the forecasting of the QoS metrics is performed in an encoder, the encoder being included in a source for the content.

22. The method of claim 11, wherein the computing comprises:
executing a predictive algorithm in response to receiving the measurements and the previously forecasted values; and
generating the new forecasted values in response to the execution of the algorithm.

23. The method of claim 22, wherein the algorithm is a model predictive algorithm.

24. The method of claim 11, wherein the QoS metrics include an end-to-end time delay experienced by the packet.

25. The method of claim 11, wherein the QoS metrics include an end-to-end time delay jitter experienced by the packet.

26. The method of claim 11, wherein the QoS metrics include anticipated packet loss experienced by the application.

27. The method of claim 11, wherein the QoS metrics include a projected throughput for the content.

28. A method for controlling a bit rate of content being generated by a distributed application, the content being transported over a best-effort network, the method comprising:
receiving a first input from a first predictive component, the first input indicative of a forecasted bit rate over a finite time horizon;
receiving a second input from a second predictive component, the second input indicative of forecasted quality of service (“QoS”) metrics of the application over the horizon, the QoS metrics defining acceptable levels of network performance; and
computing a controller output in response to the first and second inputs, wherein the bit rate is adjusted based at least partially on the controller output.

29. The method of claim 28, comprising:
receiving a third input describing time and day information; and
re-computing the controller output in response to receiving the first, second and third inputs.

30. The method of claim 28, wherein the bit rate is adjusted by scheduling departure of packets included in the content at variable inter-departure times.

31. The method of claim 28, wherein the bit rate is adjusted by scheduling departure of a plurality of packets included in the content, the departure occurring substantially simultaneously and at fixed inter-departure times.

32. The method of claim 28, wherein the bit rate is adjusted by delaying or disabling delivery of at least a portion of packets included in the content.

33. The method of claim 28, wherein the computing comprises:
executing a control algorithm in response to receiving the first and second inputs; and
generating the controller output in response to the execution of the algorithm.

34. The method of claim 33, wherein the control algorithm includes at least one prediction and forecasting algorithm.

35. The method of claim 34, wherein the prediction and forecasting algorithm is a model predictive algorithm.

36. The method of claim 34, wherein the prediction and forecasting algorithm is single-step-ahead or multi-step-ahead.

37. The method of claim 33, wherein the algorithm is linear.

38. The method of claim 33, wherein the algorithm is non-linear.

39. The method of claim 28, wherein the computing is performed by a controller, wherein the controller is configured to control a plurality of bit rates of content being generated by a corresponding plurality of distributed applications, the controlling of the plurality of bit rates occurring substantially simultaneously to meet a corresponding plurality of QoS metrics.

40. The method of claim 39, wherein the controller is independent of quantization and compression algorithms included in an encoder, the encoder being included in a source generating the content.

41. The method of claim 39, wherein the controller is included in an encoder, the encoder being included in a source for the content.

42. The method of claim 28, wherein the QoS metrics include an end-to-end time delay experienced by a packet of the content.

43. The method of claim 28, wherein the QoS metrics include an end-to-end time delay jitter experienced by a packet of the content.

44. The method of claim 28, wherein the QoS metrics include anticipated packet loss experienced by the application.

45. The method of claim 28, wherein the QoS metrics include a projected throughput for the content.

46. A method for controlling bit rate of content being generated by a distributed application, the content being transported over a best-effort network, the method comprising:
computing an expected bit rate for the content and generating a first input indicative of the expected bit rate;
computing an expected quality of service (“QoS”) metrics for the application, the QoS defining acceptable levels of network performance and generating a second input indicative of the expected QoS metrics; and
computing a controller output based at least partially on the first and second inputs, and controlling the bit rate based at least partially on the controller output.

47. The method of claim 46, comprising:
receiving real-time information for the application and generating a third input indicative of a time and day; and
recomputing the controller output in response to receiving the first, second and third inputs.

48. The method of claim 46, wherein the bit rate is adjusted by scheduling departure of packets included in the content at variable inter-departure times.

49. The method of claim 46, wherein the bit rate is adjusted by scheduling departure of a plurality of packets included in the content, the departure occurring substantially simultaneously and at fixed inter-departure times.

50. The method of claim 46, wherein the bit rate is adjusted by delaying or disabling delivery of at least a portion of packets included in the content.

51. The method of claim 46, wherein the computing of the controller output comprises:
executing a control algorithm in response to receiving the first and second inputs; and
generating the controller output in response to the execution of the algorithm.

52. The method of claim 51, wherein the control algorithm includes at least one prediction and forecasting algorithm.

53. The method of claim 52, wherein the prediction and forecasting algorithm is a model predictive algorithm.

54. The method of claim 52, wherein the prediction and forecasting algorithm is single-step-ahead or multi-step-ahead.

55. The method of claim 51, wherein the algorithm is linear.

56. The method of claim 51, wherein the algorithm is non-linear.

57. The method of claim 46, wherein the computing is performed by a controller, wherein the controller is configured to control a plurality of bit rates of content being generated by a corresponding plurality of distributed applications, the controlling of the plurality of bit rates occurring substantially simultaneously to meet a corresponding plurality of QoS metrics.

58. The method of claim 46, wherein the controller is independent of quantization and compression algorithms included in an encoder, the encoder being included in a source generating the content.

59. The method of claim 46, wherein the controller is included in an encoder, the encoder being included in a source for the content.

60. The method of claim 46, wherein the QoS metrics include an end-to-end time delay experienced by a packet of the content.

61. The method of claim 46, wherein the QoS metrics include an end-to-end time delay jitter experienced by a packet of the content.

62. The method of claim 46, wherein the QoS metrics include anticipated packet loss experienced by the application.

63. The method of claim 46, wherein the QoS metrics include a projected throughput for the content.

64. An active content control (ACC) system operable to control delivery of content across a best-effort network, the system comprising:
a processor;
the network coupled to the processor; and
a memory storing instructions operable with the processor, the instructions being executed for:
computing an expected bit rate for the content and generating a first input indicative of the expected bit rate;
computing an expected quality of service (“QoS”) metrics for the application, the QoS defining acceptable levels of network performance and generating a second input indicative of the expected QoS metrics; and
computing a controller output based at least partially on the first and second inputs, and controlling the bit rate based at least partially on the controller output.

65. The system of claim 64, comprising:
receiving real-time information for the application and generating a third input indicative of a time and day; and
re-computing the controller output in response to receiving the first, second and third inputs.

66. The system of claim 64, wherein the bit rate is adjusted by scheduling departure of packets included in the content at variable inter-departure times.

67. The system of claim 64, wherein the bit rate is adjusted by scheduling departure of a plurality of packets included in the content, the departure occurring substantially simultaneously and at fixed inter-departure times.

68. The system of claim 64, wherein the bit rate is adjusted by delaying or disabling delivery of at least a portion of packets included in the content.

69. The system of claim 64, wherein the computing of the controller output comprises:
executing a control algorithm in response to receiving the first and second inputs; and
generating the controller output in response to the execution of the algorithm.

70. The method of claim 69, wherein the control algorithm includes at least one prediction and forecasting algorithm.

71. The method of claim 70, wherein the prediction and forecasting algorithm is a model predictive algorithm.

72. The method of claim 70, wherein the prediction and forecasting algorithm is single-step-ahead or multi-step-ahead.

73. The method of claim 69, wherein the algorithm is linear.

74. The method of claim 69, wherein the algorithm is non-linear.

75. The system of claim 64, wherein the computing is performed by a controller, wherein the controller is configured to control a plurality of bit rates of content being generated by a corresponding plurality of distributed applications, the controlling of the plurality of bit rates occurring substantially simultaneously to meet a corresponding plurality of QoS metrics.

76. The system of claim 64, wherein the controller is independent of quantization and compression algorithms included in an encoder, the encoder being included in a source generating the content.

77. The system of claim 64, wherein the controller is included in an encoder, the encoder being included in a source for the content, the source being coupled to the network.

78. The system of claim 64, wherein the QoS metrics include an end-to-end time delay experienced by a packet of the content.

79. The system of claim 64, wherein the QoS metrics include an end-to-end time delay jitter experienced by a packet of the content.

80. The system of claim 64, wherein the QoS metrics include anticipated packet loss experienced by the application.

81. The system of claim 64, wherein the QoS metrics include a projected throughput for the content.

82. A computer program product for an active content control (ACC) system operable to control delivery of content across a best-effort network, the computer program product comprising:
instructions for computing an expected bit rate for the content and generating a first input indicative of the expected bit rate;
instructions for computing an expected quality of service (“QoS”) metrics for the application, the QoS defining acceptable levels of network performance and generating a second input indicative of the expected QoS metrics; and
instructions for computing a controller output based at least partially on the first and second inputs, and controlling the bit rate based at least partially on the controller output.

83. The computer program product of claim 82, comprising:
receiving real-time information for the application and generating a third input indicative of a time and day, and
re-computing the controller output in response to receiving the first, second and third inputs.

84. The computer program product of claim 82, wherein the bit rate is adjusted by scheduling departure of packets included in the content at variable inter-departure times.

85. The computer program product of claim 82, wherein the bit rate is adjusted by scheduling departure of a plurality of packets included in the content, the departure occurring substantially simultaneously and at fixed inter-departure times.

86. The computer program product of claim 82, wherein the bit rate is adjusted by delaying or disabling delivery of at least a portion of packets included in the content.

87. The computer program product of claim 82, wherein the computing of the controller output comprises:
executing a control algorithm in response to receiving the first and second inputs; and
generating the controller output in response to the execution of the algorithm.

88. The computer program product of claim 87, wherein the control algorithm includes at least one prediction and forecasting algorithm.

89. The computer program product of claim 88, wherein the prediction and forecasting algorithm is a model predictive algorithm.

90. The computer program product of claim 88, wherein the prediction and forecasting algorithm is single-step-ahead or multi-step-ahead.

91. The computer program product of claim 87, wherein the algorithm is linear.

92. The computer program product of claim 87, wherein the algorithm is non-linear.

93. The computer program product of claim 82, wherein the computing is performed by a controller, wherein the controller is configured to control a plurality of bit rates of content being generated by a corresponding plurality of distributed applications, the controlling of the plurality of bit rates occurring substantially simultaneously to meet a corresponding plurality of QoS metrics.

94. The computer program product of claim 82, wherein the controller is independent of quantization and compression algorithms included in an encoder, the encoder being included in a source generating the content.

95. The computer program product of claim 82, wherein the controller is included in an encoder, the encoder being included in a source for the content, the source being coupled to the network.

96. The computer program product of claim 82, wherein the QoS metrics include an end-to-end time delay experienced by a packet of the content.

97. The computer program product of claim 82, wherein the QoS metrics include an end-to-end time delay jitter experienced by a packet of the content.

98. The computer program product of claim 82, wherein the QoS metrics include anticipated packet loss experienced by the application.

99. The computer program product of claim 82, wherein the QoS metrics include a projected throughput for the content.
